(19) United States
(12) Patent Application Publication
(10) Pub. No.: US 2006/0225037 A1
(43) Pub. Date: Oct. 5, 2006

(54) Enabling UI template customization and reuse through parameterization

(75) Inventors: Christopher Glein, Seattle, WA (US); Francis Hogle, Bellevue, WA (US); Jeffrey Stall, Redmond, WA (US); Luciano Mandryk, Seattle, WA (US); Mark Finocchio, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/095,758

(22) Filed: Mar. 30, 2005

(51) Int. Cl. G06F 9/44

(52) U.S. Cl. 717/117

(57) ABSTRACT

An exemplary computer-implementable method includes declaring a template for a user interface component in a markup language where the template specifies one or more parameters for the user interface component and declaring a parent template for a user interface assembly of components in the markup language where the parent template calls for consumption of the template for the user interface component and provides at least one value for the one or more parameters or optionally relies exclusively on a default value or default values for one or more parameters. Various other exemplary methods, devices, systems, etc., are also disclosed.

### RELATED APPLICATIONS

This application is related to U.S. Patent Application entitled “Context menu navigational method for accessing contextual and product-wide choices via remote control”, to Ostojic, Glein and Sands, filed on Mar. 30, 2005, having Attorney Docket No. MS1-2490US (which is incorporated by reference herein); U.S. Patent Application entitled “System and method for dynamic creation and management of lists on a distance user interface”, to Ostojic, filed on Mar. 30, 2005, having Attorney Docket No. MS1-2489US (which is incorporated by reference herein); and U.S. Patent Application entitled “System for efficient remote projection of rich interactive user interfaces”, to Hogle, filed on Mar. 30, 2005, having Attorney Docket No. MS1-2491US (which is incorporated by reference herein).

### TECHNICAL FIELD

Subject matter disclosed herein relates generally to user interfaces for display on a computer monitor, a television, a projector screen, etc.

### BACKGROUND

Development of a user interface can be a time consuming process that requires many iterations. Further, developers often want to distinguish the look and feel of an application from other applications. Yet further, a particular application's user interface in one context may not suffice in a different context. For example, a user interface for an application operating in a 2′ context via keyboard and mouse input may not provide the user with a good experience when implemented in a 10′ context where input is via a remote control. Indeed, use of a UI developed for a 2′ context, when used in a 10′ context, may deter use.

In general, a user's visual experience in the 10′ context is in many ways more critical than in the 2′ context. The 2′ context is more akin to reading a book (i.e., “normal” text and image presentation) and being able to point at the text or images with your finger while the 10′ context is more akin to watching TV, where a remote control is aimed at a device, where viewing habits for users are quite varied and where viewers are more accustomed to viewing images, single words or short phrases, as opposed to lines of text.

Without a doubt, the advent of the 10′ context has raised new issues in the development of user interfaces. On one hand, a user interface in the 10′ context cannot effectively display as much information as a user interface in the 2′ context. On the other hand, this offers an opportunity to simplify or ease user interface development by providing a small set of proven and useful user interface components. As described herein, various exemplary methods, devices, systems, etc., aim to facilitate user interface development. In various instances, such exemplary technology can facilitate development of user interfaces in the 10′ context where limitations exist on the space available for meaningful display of information and interaction with such information.

### SUMMARY

The techniques and mechanisms described herein are directed at development and creation of user interfaces. An exemplary computer-implementable method includes declaring a template for a user interface component in a markup language where the template specifies one or more parameters for the user interface component and declaring a parent template for a user interface assembly of components in the markup language where the parent template calls for consumption of the template for the user interface component and provides at least one value for the one or more parameters or optionally relies exclusively on a default value or default values for the one or more parameters. Various other exemplary methods, devices, systems, etc., are also disclosed.

### BRIEF DESCRIPTION OF THE DRAWINGS

Non-limiting and non-exhaustive examples are described with reference to the following figures, wherein like reference numerals refer to like parts throughout the various views unless otherwise specified.

FIG. 1 is a diagram of an exemplary context that includes a display to display a user interface and a remote control for input and interaction with the user interface.

FIG. 2 is a diagram of exemplary templates in a hierarchy and as parameterized.

FIG. 3 is a diagram of an exemplary method for hosting templates in a markup language via hosting to create a user interface.

FIG. 4 is a diagram of an exemplary method that includes an exemplary builder application for building a user interface and generating markup language for use in creating the user interface.

FIG. 5 is a diagram illustrating an exemplary computing environment, which may be used to implement various exemplary technologies described herein.

### DETAILED DESCRIPTION

In the description that follows, various exemplary methods, devices, systems, etc., are presented. These examples rely on a markup language to parameterize one or more templates for use in developing or creating a user interface. As described in the Background Section, limitations exist in the 10′ context and exemplary technology presented herein is particularly useful for user interfaces for the 10′ context; however, such exemplary technology may be used for other contexts. In particular, such exemplary technology may be used where reusable templates facilitate development or generation of user interfaces.

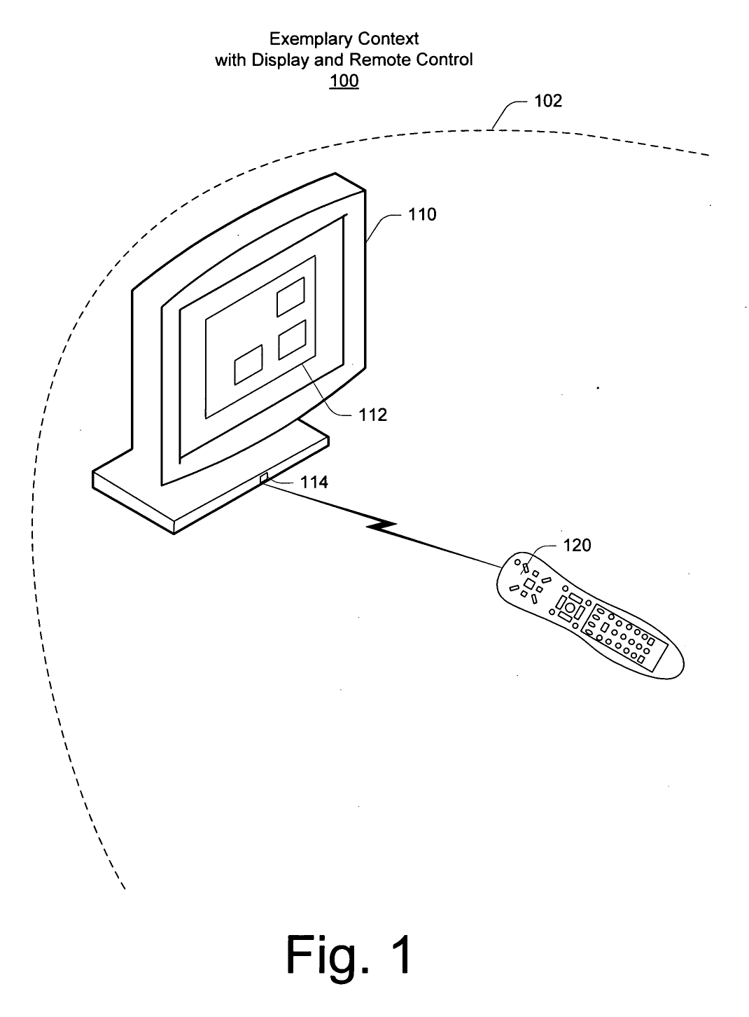

FIG. 1 shows an exemplary context 100 that has a context boundary 102 (e.g., 10′ or other distance). The context boundary 102 is typically defined by a distance or distances between a user and a user interface (UI). The exemplary context 100 is akin to a distance typically found in viewing TV. In the exemplary context 100, a display 110 displays a UI 112 and a remote control 120 communicates with a controller for the display via a communication port 114, which is typically a wireless communication port (e.g., infrared, etc.). The controller for the display 110 may be a computer located proximate to the display 110 or located remote from the display 110. Various communication techniques exist to allow a computer to provide display information to create a UI.

A user interface that works well at a distance of about ten feet should account for the fact that a typical remote control (e.g., the remote control 120) is smaller and easier to use than a conventional keyboard and mouse; however, it generally provides a more limited form of user input (e.g., due to fewer keys or buttons). And while a greater viewing distance provides a more comfortable experience, it can necessitate features that provide a visual design style to ensure clarity, coherence, and readability.

In both the 2′ context and the 10′ context, the user's expectations, mobility, habits, etc., should be considered when constructing a user interface (e.g., the UI 112). With respect to expectations, the 10′ experience is more like watching television than using a computer. As a result, users expect a dynamic, animated experience. They expect that the input device will make their experience simpler, not more complicated. They may also expect applications to be more convenient, simpler to learn, and easier to use than applications controlled by the keyboard or mouse.

As described herein, various exemplary methods, devices, systems, etc., allow for construction of user interfaces using a markup language. More specifically, various examples use a UI framework that describes UI constructs using XML “templates”. XML templates are advantageous in that they are not monolithic XML UI documents per se. Rather, the exemplary XML templates are grouped into smaller, logical reusable components. For example, an XML template may describe the look and feel of a list and another XML template may describe the look and a feel of a list item. Such a combination of templates leads to a good combination of flexibility (e.g., easier to tease apart one part of the look and feel and change it independently) and reusability (e.g., a button template can be stamped out just about anywhere).

To facilitate operability of such a UI framework, one or more exemplary methods allow for or manage communication between the templates. For example, if a child template is making use of a parent template, the parent template needs to know how to communicate required data to the child template. Consider a parent list template and one or more child list item templates where the parent list template needs to give each instance (i.e., each child) of the list item template a list item. In general, such communication is based on parameterization specified in a markup language.

Such a UI framework should promote reusability, for example, where small targeted templates are flexible and reusable. Without reusability, a UI framework would need a different template for every permutation of a particular core look and feel, which would result in significant production and organization issues. In general, a UI refers to a graphical user interface, for example, as displayed on a screen, a monitor, by a projector, etc.

General User Interface Guidelines

In the 10′ context, the display may be a TV display, a computer monitor display or a projection screen display. With the advent of HDTVs, LCDs, plasma monitors, interoperability (TV or computer monitor) is often available in a single display.

General guidelines include text and graphics that are sufficiently large for display using lower clarity and resolution associated with a conventional TV display; caution when relying on fixed widths; size and position graphics relative to the screen resolution; avoid use of fine details that may blur on a conventional TV display; where limitations of interlaced scanning are present, size all lines, borders, and text to at least two pixels wide; and be aware that bright colors tend to over-saturate on a conventional TV display.

With respect to text, it is recommended to size all text, especially for critical content such as buttons and links, to at least 20 points. In addition, it is recommended to use lists of short phrases rather than paragraphs; move larger blocks of text onto secondary pages; edit text to remove any nonessential information; to use adequate contrast between text and its background, and to use light and dark values to create contrast.

With respect to a look and feel for UI buttons, an exemplary scheme may use a basic look for buttons associated a particular application (e.g., a basic look for links, option buttons, check boxes, sorting controls, controls to set the view, etc.). Where more than one application requires UI display, each application may have its own look. Such a scheme provides a user with a consistent experience and can help enable the user to quickly identify which items on the page are functional or used for navigation.

It is recommended that buttons be clearly visible against their surroundings and that the functions that they perform be inherent or obvious. For example, a label on a button may describe its function. For example, users can be expected to understand the function of “Save Settings” or “Play DVD” more easily than “OK” or “Go”.

It is recommended that when a user focuses on a button, the button be highlighted in a visually distinct manner, making it more visible than buttons that do not have the focus. A highlighting effect can be achieved by changing the background color of the button, or by placing a brightly colored border around the button.

For consistency and ease of use, a single consistent style of highlighting is recommended for each application (e.g., a highlight color that complements the colors of a particular design). Highlighting is part of a dynamic user experience; users generally notice highlights not just because of their contrast with other elements, but because of the movement of the highlight as they navigate around the page.

In the 10′ context, navigation should refer to not only movement between pages or screens, but also movement between selectable elements within a page. With respect to a remote control, users generally navigate by using the arrow buttons on the remote control to move the input focus to a particular item and then press “enter” to act on the focused item. For most UIs, it is typically recommended that the focus is always on one of the items in the UI.

In the 10′ context, it is recommended that page layouts be simple and clean, with a coherent visual hierarchy. A consistent design, from page to page, may include aligning UI items to a grid. It is further recommended that readability take precedence over decoration and that the inclusion of too many extraneous visual elements be avoided.

In the WINDOWS® MEDIA CENTER EDITION™ operating system (Microsoft Corporation, Redmond, Wash.), when a user opens a non-native application while video or TV is playing, the MEDIA CENTER EDITION™ operating system or native application thereof (unless otherwise instructed), will move the media playback into a small window at the lower left of the screen, called a shared viewport. When the shared viewport is visible, it will cover any content in the lower left corner of the non-native application's UI (i.e., displayed page). For example, the viewport has a width of 274 pixels and a height of 192 pixels for a screen resolution of 1024×768. Thus, an exemplary UI framework may account for other applications that may run concurrently with a particular application. Of course, a user may develop a UI with knowledge of such native behavior or behavior of other applications that may operate concurrently. As an alternative, with respect to the viewport, a script to close the shared viewport could be used.

Markup Language

As already mentioned, an exemplary UI framework relies on a markup language. A particular markup language is the Extensible Markup Language (XML), which is the current universal format for data on the Web. XML allows developers to easily describe and deliver rich, structured data in a standard, consistent way. XML is a complementary format to HTML and both are derived from the Standard Generalized Markup Language (SGML); however, unlike HTML, XML does not have a fixed vocabulary.

XML is a plain-text language that is not tied to any programming language, operating system, or software vendor. XML may be considered a meta-language that can be used for defining markup languages. XML provides access to a plethora of technologies for manipulating, structuring, transforming and querying data. SGML and XML are text-based formats that provide mechanisms for describing document structures using markup elements or tags (words surrounded by “<” and “>”). XML can easily represent both tabular data (such as relational data from a database or spreadsheets) and semi-structured data (such as a Web page or business document).

Applications that process or consume XML formats are generally more resistant to changes in the structure of the XML being provided to them than applications that use other formats, as long as such changes are additive. For example, an application that depends on processing a <Customer> element (i.e., “Customer” markup tag) with a “customer-id” attribute typically would not break if another attribute, such as “last-purchase-date”, was added to the <Customer> element.

In terms of structure, an XML “document” is made up of one or more elements, each of which consists of a “start tag” (e.g., <order>), an “end tag” (e.g., </order>), and the information between the start tag and the end tag, which may be referred to as the contents of the element. Elements can be annotated with attributes that contain metadata about the element and its contents. A simple, sample XML segment to specify data for various attributes follows:

Sample Segment 1

<address>

<street>One Microsoft Way</street>
<city>Redmond</city>
<state>WA</state>
<zip>98052</zip>

</address>

Exemplary UI Framework using Markup Language

An exemplary UI framework uses a markup language to specify various templates. The use of a markup language allows for parameterization of UI elements, or components, where each element may be represented as an individual template. Where appropriate, a parameter value or values for one element may be shared with or communicated to another element. According to the exemplary UI framework, a UI has a structure that can be written or defined in XML syntax. In particular, a UI structure is composed of one or more UI templates that rely on XML.

To explain the use of a markup language for a UI, consider that a particular UI or view may be thought of as a “View Template” or as a function. In an example that follows, a View Template named “MyView” and a function named “MyView” are compared to help explain UI template parameterization through use of a markup language. The two parameter function “MyView” is declared as:

Sample Segment 2
void MyView(Int32 param1, Size param2)

According to the exemplary UI framework, the View Template named “MyView”, is parameterized with parameters param1 and param2. The View Template can be declared in XML as follows:

Sample Segment 3

<UI Name=“MyView”>

<Properties>

<Int32 Name=“param1” Int32=“$Required”/>
<Size Name=“param2” Size=“$Required”/>

</Properties>
...

</UI>

The sample XML segment (Segment 3) declares that the View Template “MyView” requires an Int32 parameter or property named “param1” and a Size parameter or property named “param2”. Thus, the XML segment provides the declaration of a “function” signature. Of course, the purpose of a function is to be invoked. The following segment of code could be used to invoke the function “MyView”:

Sample Segment 4
Int32 param1=new Int32(12);
Size param2;
param2.Width=5;
param2.Height=5;
MyView(param1, param2);

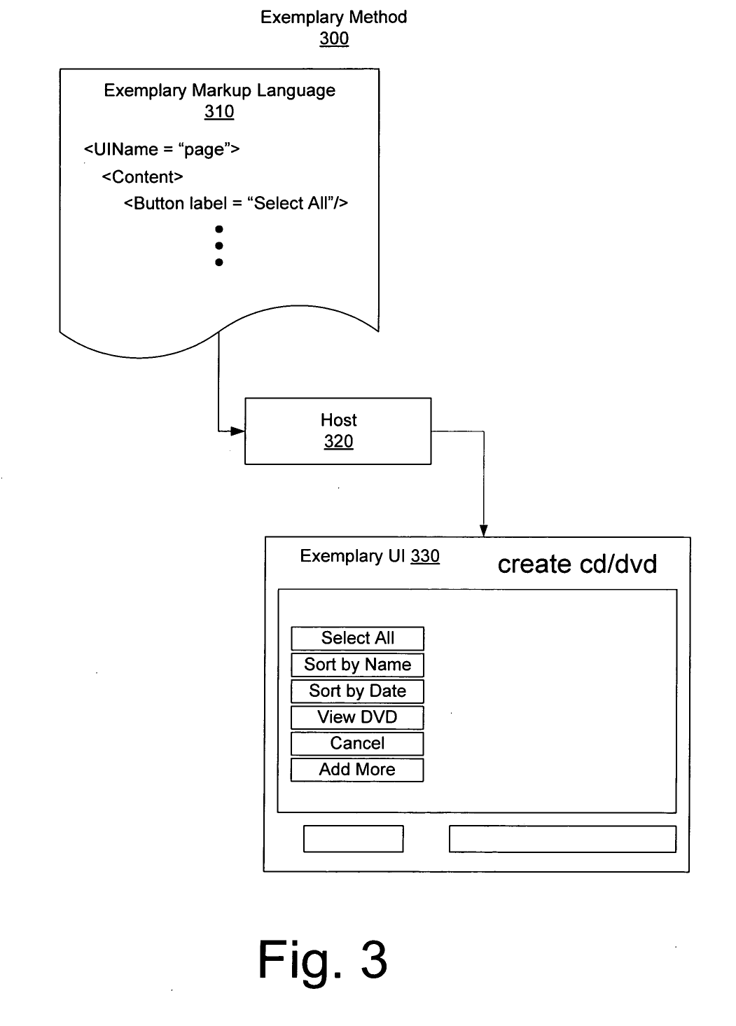

The exemplary UI framework describes the invocation for the View Template in XML via a host (see also the host 320 of FIG. 3):

Sample Segment 5

<MyView>

<param1>

<Int32 Int32=12”/>

</param1>
<param2>

<Size Width=“5” Height=“5”/>

</param2>

</MyView>

In this sample segment (Segment 5), “MyView” sets forth param1 and param2, such a segment may be hosted to thereby express the values of “MyView”.

The exemplary UI framework thus allows a template to be parameterized whereby a markup language template acts like a function and the one or more parameters or attributes act like function parameters. Accordingly, there can now be named points of flexibility where such a template can be permuted differently based on its invocation while still having a shared core.

Much like functions in some programming languages, markup language templates can have default values for any or all of their parameters. Use of a default value or values thereby allows a template to have a default configuration, which can speed development of a UI.

An exemplary template may include one or more default values, optional values or required values or any combination of these three types of values. Returning to the “MyView” example, as a function, a default size of 10×10 could be declared as follows:

Sample Segment 6
void MyView(Int32 param1, Size param2=new Size(10, 10));

In markup language, the View Template “MyView” can declare param1 as a required parameter and param2, the size parameter, to a default of 10×10 as follows:

Sample Segement 7

<UI Name=“MyView”>

<Properties>

<Int32 Name=“param1” Int32=”$Required”/>
<Size Name=“param2” Size=“10, 10”/>

</Properties>
...

</UI>

Upon hosting the View Template “MyView”, a user could abstain from specifying the Size parameter using the following XML segment:

Sample Segment 8

<MyView>

<param1>

<Int32 Int32=“12”/>

</param1>

</MyView>

Of course, an even simpler representation may be possible using a start tag and an end tag (e.g., <MyView param1=“12”> followed by </MyView>). A user could optionally override the default parameter value settings with a different value.

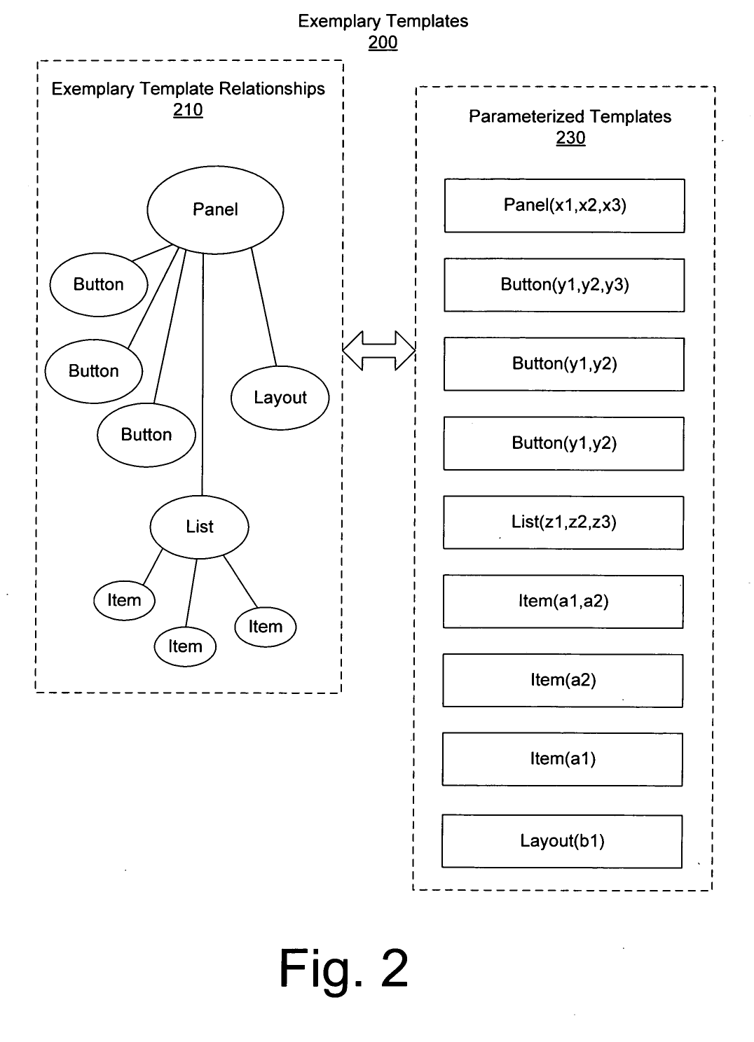

FIG. 2 shows exemplary templates 200 in an exemplary UI template hierarchy with relationships between various templates. The exemplary template relationships 210 include a parent panel with various children. The children include “button” template children, a “list” template child and a “vertical” template child. Further, the list template has three list item children. Thus, the UI “panel” is represented as a group of templates whereby a parent template can consume a child template and optionally provide one or more values for one or more parameters.

In the example of FIG. 2, the exemplary templates 210 are parameterized as set forth in the parameterized templates 230. For example, the panel template includes parameters x1, x2 and x3. These parameters may correspond to a certain look or feel for the panel (i.e., selection of parameters and parameter values creates a template that describes the look and feel of a panel). Each button in the templates 210 is based on a template with parameters y1, y2, y3 that specify aspects of a look or feel germane to the user experience. One of the button templates relies on parameters y1, y2 and y3 whereas the other two button templates rely on parameters y1 and y2. For example, the parameter y3 may be optional. Thus, a single button template may offer flexibility through selection of parameters or selection of parameter values.

For example, the following segment of markup language may represent a template hierarchy pertaining to the panel, a layout and the three buttons:

Sample Segment 9

<Panel>

<Layout>
<HorizontalFlowLayout ItemAlignment=“Center”/>
</Layout>
<Children>

<Button Code=“$Path(Start)” ShowLabel=“false”
Background=“$Image(res://mydll.dll!Logo.png)”
FocusBackground=“$Image(res://mydll.dll!LogoFocus.png)”
ClickSound=“$Sound(res://mydll.dll!Click.wav)”/>
<Button Code=“$Path(Back)” ShowLabel=“false”
Background=“$Image(res://mydll.dll!BackArrow.png)”
FocusBackground=“$Image(res://mydll.dll!BackArrowFocus.png)”/>
<Button Code=“$Path(Forward)” ShowLabel=“false”
Background=“$Image(res://mydll.dll!ForwardArrow.png)”
FocusBackground=“$Image(res://mydll.dll!ForwardArrowFocus.png)”/>

</Children>

</Panel>

In this sample segment (Segment 9), the panel template consumes the layout and three buttons. The layout is specified as being a horizontal flow layout for alignment of UI components or “items”. The three button templates are consumed as children of the panel template whereby parameters are selected and parameter values provided (see, e.g., Sample Segment 11, below, which is a button template that specifies various parameters without providing values). In Sample Segment 9, the first button is provided with information to specify a “Start” button with a particular background, a focus background and a click sound (e.g., the parameters y1, y2 and y3). The second button is provided with information to specify a “Back” button with a particular background and a focus background (e.g., the parameters y1 and y2). The third button is provided with information to specify a “Forward” button with a particular background and a focus background (e.g., the parameters y1 and y2). Strings or other information may be considered values for a parameter or parameters.

Sample Segment 9 or other segments may be part of a UI assembly (e.g., group of elements or components). For example, Sample Segment 9 may be consumed as content for a UI menu according to the following sample segment:

Sample Segment 10

<UI Name=“MenuBlock”>

<Properties>

<Command Name=“Start”/>
<Command Name=“Back”/>
<Command Name=“Forward”/>

</Properties>
<Content>

[Insert Content Here, e.g., Sample Segment 9]

</Content>

</UI>

In this sample segment (Segment 10), a UI Name is specified as “MenuBlock” with three command properties: Start, Back and Forward. These properties are then associated with the button templates (see Sample Segment 9) which are content of the menu block.

Referring again to the various templates in the exemplary hierarchy 210, the list template includes parameters z1, z2 and z3, which specify aspects of a look or feel germane to the user experience. For example, where a developer wishes to distinguish a list for one application from a list for another application, a list template may include a parameter for specifying square or rounded corners, a parameter for specifying shadows, a parameter for specifying color, a parameter for specifying font of a list title, etc. Such parameters are useful for distinguishing a look and feel for one application from a look and feel for another application. In general, a particular template may aim to optimize the parameter set by limiting the set to a few parameters that can yield a significant impact on the user experience.

The list item template includes parameters a1 and a2. In this example, one of the list items specifies parameter a1 and a2, another list item specifies a2 only and yet another list item specifies a1 only. Thus, as explained, the flexible templates in the exemplary hierarchy 210 may be consumed as appropriate to produce a UI.

The exemplary UI framework described with respect to FIG. 2 uses markup language templates that can be grouped into smaller, logical reusable components. Such an exemplary framework combines flexibility (e.g., easier to tease apart one part of the look and feel and change it independently) and reusability (e.g., the same button template can be stamped out just about anywhere).

The example of FIG. 2 pertains to an exemplary UI framework that uses markup language. The example of FIG. 2 also exhibits parameterization using markup language. An exemplary template for a UI component or element may have no parameters or one or more parameters. A more detailed, multiple parameter sample segment for a button template suitable for use in the example of FIG. 2 appears below:

Sample Segment 11

<UI Name=“Button” Behavior=“ButtonBehavior”>

<Properties>

<Command Name=“Code” Description=“Default”/>
<Font Name=“LabelFont” FontName=“Impact” FontSize=“16”/>
<Color Name=“LabelColor” A=“255” R=“245” G=“163” B=“206”/>
<Color Name=“HoverLabelColor” A=“255” R=“242” G=“242” B=“242”/>
<Color Name=“FocusLabelColor” A=“255” R=“242” G=“242” B=“242”/>
<Inset Name=“LabelInset”/>
<Boolean Name=“ShowLabel” Boolean=“true”/>
<Image Name=“Background” Image=“null”/>
<Image Name=“FocusBackground” Image=“null”/>
<Sound Name=“ClickSound” Sound=“null”/>

</Properties>
<Rules>
<Default Target=“$Path(Behavior.Model)” Value=“$Path(Code)”/>
<Binding Source=“$Path(Background)” Target=“$Path(Chrome.Image)”/>
<Binding Source=“$Path(LabelInset)” Target=“$Path(Chrome.Margins)”/>
<Binding Source=“$Path(ShowLabel)” Target=“$Path(Chrome.SizeToContent)”/>
<Binding Source=“$Path(ShowLabel)” Target=“$Path(Label.Visible)”/>
<Condition Source=“$Path(Behavior.MouseFocus)” ConditionValue=“true”>

<Actions>

<Set Target=“$Path(Label.Color)” Value=“$Path(HoverLabelColor)”/>

</Actions>

</Condition>
<Rule>

<Conditions>

<Equality Source=“$Path(FocusBackground)” ConditionOp=“NotEquals”

Value=”null”/>

<Equality Source=“$Path(Behavior.KeyFocus)” Value=“true”/>

</Conditions>
<Actions>

<Set Target=“$Path(Chrome.Image)”

Value=“$Path(FocusBackground)”/>
</Actions>

</Rule>
<Condition Source=“$Path(Behavior.KeyFocus)” ConditionValue=“true”
Target=“$Path(Label.Color)” Value=“$Path(FocusLabelColor)”/>
<Changed Source=“$Path(Code.Invoked)”>

<Actions>

<PlaySound Sound=“$Path(ClickSound)”/>

</Actions>

</Changed>
</Rules>
<Content>
<Graphic ID=“Chrome” Image=“$Path(Background)” MouseInteractive=“true”>

<Animation>$Animation(ButtonContentShow)</Animation>

<Children>

<SimpleText ID=“Label” Content=“$Path(Code.Description)”
Color=”$Path(LabelColor)” Font=“$Path(LabelFont)”>
<Animation>$Animation(ButtonContentHide)</Animation>
<Animation>$Animation(ButtonContentShow)</Animation>.
</SimpleText>

</Children>

</Graphic>
</Content>

</UI>

This sample segment (Segment 11) includes various properties, rules, conditions, actions, content, children, graphics, etc. This exemplary segment for declaration of a “button” template can be used for a variety of looks as it is flexible and reusable.

Thus, as described, an exemplary method may declare a template for a user interface component in a markup language where the template specifies one or more parameters for the user interface component (e.g., Sample Segment 11) and declare a parent template for a user interface assembly of components in the markup language where the parent template calls for consumption of the template for the user interface component and provides at least one value for the one or more parameters (e.g., Sample Segment 9 or Sample Segment 10 with Sample Segment 9 inserted as content where Sample Segment 9 relies on Sample Segment 11) or optionally relies on default values for the one or more parameters. Of course, such an exemplary method is not limited to the specific sample segments presented.

An exemplary method may declare a parent template for a user interface assembly of components in the markup language where the parent template calls for a first consumption of the user interface component and where the parent template calls for a second consumption of the user interface component (see, e.g., Sample Segment 9 or Sample Segment 10 with Sample Segment 9 inserted as content). Use of one or more default values for the one or more parameters may optionally occur and knowledge of use of such values or the values themselves may optionally be communicated between parent and child, as appropriate or as required.

While various exemplary templates include one or more parameters, an exemplary template that does not include a parameter may exist for a user interface component. For example, consider a star rating for a song, a movie, etc., which is specified by one or more stars as user interface components. While various exemplary templates may be used to specify requisite data such as a song title, artist name, and number of stars, which include some parameters, a template may exist for the look and feel of a star (e.g., a star composed of many assets layered together with interesting layouts) that does not include any parameters. Such a template can avoid having to duplicate an elaborate or complicated description of such a star. Thus, a packaging or other layer can still be useful even if the user interface template does not take parameters.

FIG. 3 shows an exemplary method 300 for creating a UI 330 using exemplary markup language 310 for the UI 330. While the exemplary markup language appears as a document, the exemplary UI framework does not requires a monolithic document. Instead small segments of markup language suffice for defining elements or components of a UI.

The exemplary markup language 310 optionally includes features of any of the various markup language segments above. The markup language 310 is hosted by host 320. The process of hosting can create the exemplary UI 330 based on the exemplary markup language 310. In this example, the exemplary UI 330 is to allow a user to create a cd or dvd. Such a UI is suitable for use in a 10′ context or other context (see, e.g., the exemplary context 100 of FIG. 1 where the UI is driven by a remote control).

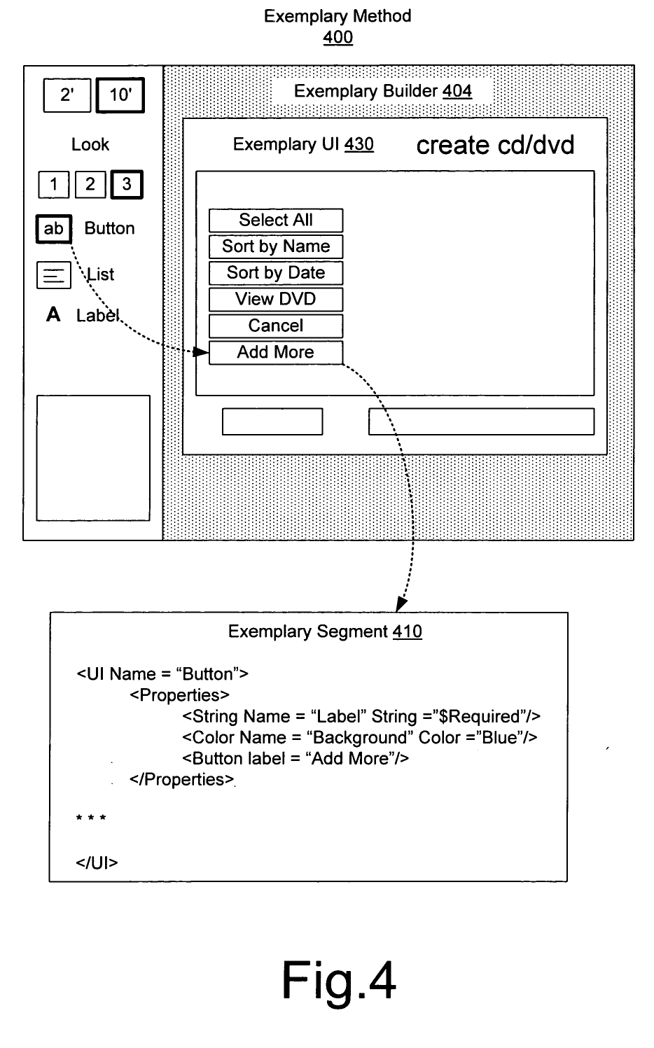

FIG. 4 shows an exemplary method 400 that uses an exemplary UI builder application 404 for creating a UI 430 and corresponding markup language 410. The exemplary UI builder application 404 includes various buttons such as context buttons (e.g., a 2′ context button, a 10′ context button). Various looks may be predefined and optionally associated with a context. For example, the 10′ context may include three predefined looks (e.g., 1, 2 and 3). For example, look “1” may specify a blue color scheme and rounded corners while look “2” may specify a red color scheme and square corners. Various icons may be presented that correspond to various UI components (e.g., button, list, text, etc.).

A user may use a drag and drop function to position UI components in a builder form that displays the exemplary UI 430. Upon dropping a component, the builder application 404 generates markup language segment 410. Upon saving the developed UI, or publishing the developed UI, a procedure may determine if any required parameters for a component have not been specified and notify the user. For example, property “String Name” has a required label string. If a user fails to specify the label, a message may notify the user that a label is required. Alternatively, a default value may be used to prevent notification.

An exemplary method may include positioning an icon for a user interface component on a form and creating an instance of a template in a markup language for the user interface component where the template specifies one or more parameters for the user interface component. Again, use of default values may occur for the one or more parameters. Where a default value or value is used, consumption or an instance of a template may specify a value or values for the one or more parameters inherently or implicitly, as opposed to specifying a value or values for the one or more parameters expressly or explicitly (e.g., as between a “start” tag and an “end” tag, etc.).

An exemplary method may include declaring a template for a user interface component in a markup language where the template specifies one or more parameters for the user interface component and declaring a parent template for a user interface assembly of components in the markup language where the parent template calls for consumption of the template for the user interface component and provides at least one value for the one or more parameters or relies exclusively on a default value or default values for the one or more parameters. A parent template optionally calls for consumption of a template without providing a value, for example, where expression of the template relies on one or more default values for a parameter or parameters.

The exemplary markup language framework described herein facilitates UI development and allows for communication between UIs, UI components, etc., using parameters. Templates declared in markup language are reusable to create a variety of looks. Use of default values can further facilitate development.

Exemplary Computing Environment

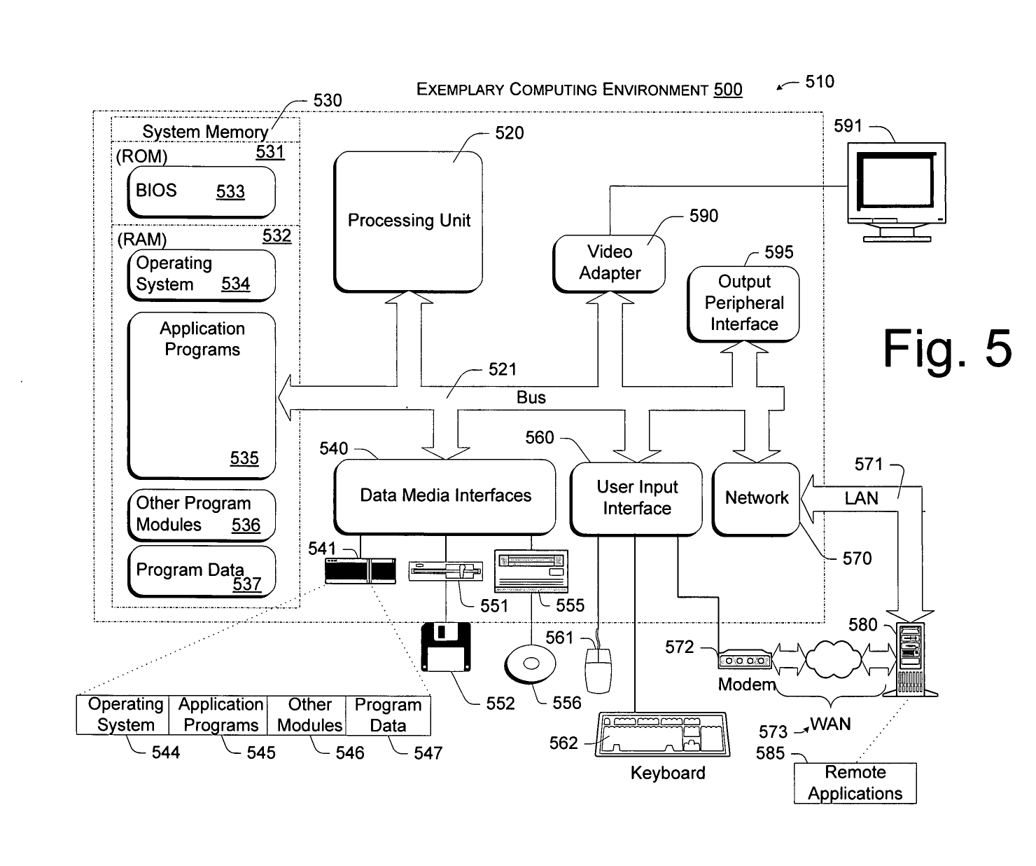

The various examples may be implemented in different computer environments. The computer environment shown in FIG. 5 is only one example of a computer environment and is not intended to suggest any limitation as to the scope of use or functionality of the computer and network architectures suitable for use. Neither should the computer environment be interpreted as having any dependency or requirement relating to any one or combination of components illustrated in the example computer environment.

FIG. 5 illustrates an example of a suitable computing system environment 500 on which various exemplary methods may be implemented. Various exemplary devices or systems may include any of the features of the exemplary environment 500. The computing system environment 500 is only one example of a suitable computing environment and is not intended to suggest any limitation as to the scope of use or functionality of the invention. Neither should the computing environment 500 be interpreted as having any dependency or requirement relating to any one or combination of components illustrated in the exemplary operating environment 500.

Various exemplary methods are operational with numerous other general purpose or special purpose computing system environments or configurations. Examples of well known computing systems, environments, and/or configurations that may be suitable for implementation or use include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like. For example, the exemplary context 100 of FIG. 1 may use a remote computer to generate information for display of a UI wherein the displayed UI operates in conjunction with a remote control or other input device.

Various exemplary methods, applications, etc., may be described in the general context of computer-executable instructions, such as program modules, being executed by a computer. Generally, program modules include routines, programs, objects, components, data structures, etc., that perform particular tasks or implement particular abstract data types. Various exemplary methods may also be practiced in distributed computing environments where tasks are performed by remote processing devices that are linked through a communications network or other communication (e.g., infrared, etc.). In a distributed computing environment, program modules may be located in both local and remote computer storage media including memory storage devices.

With reference to FIG. 5, an exemplary system for implementing the various exemplary methods includes a general purpose computing device in the form of a computer 510. Components of computer 510 may include, but are not limited to, a processing unit 520, a system memory 530, and a system bus 521 that couples various system components including the system memory 530 to the processing unit 520. The system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 510 typically includes a variety of computer readable media. Computer readable media can be any available media that can be accessed by computer 510 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 510. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 530 includes computer storage media in the form of volatile and/or nonvolatile memory such as read only memory (ROM) 531 and random access memory (RAM) 532. A basic input/output system 533 (BIOS), containing the basic routines that help to transfer information between elements within computer 510, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, application programs 535, other program modules 536, and program data 537.

The computer 510 may also include other removable/non-removable, volatile/nonvolatile computer storage media. By way of example only, FIG. 5 illustrates a hard disk drive 541 that reads from or writes to non-removable, nonvolatile magnetic media, a magnetic disk drive 551 that reads from or writes to a removable, nonvolatile magnetic disk 552, and an optical disk drive 555 that reads from or writes to a removable, nonvolatile optical disk 556 such as a CD ROM or other optical media (e.g., DVD, etc.). Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 541 is typically connected to the system bus 521 through a data media interface such as interface 540, and magnetic disk drive 551 and optical disk drive 555 are typically connected to the system bus 521 a data media interface that is optionally a removable memory interface. For purposes of explanation of the particular example, the magnetic disk drive 551 and the optical disk drive use the data media interface 540.

The drives and their associated computer storage media discussed above and illustrated in FIG. 5, provide storage of computer readable instructions, data structures, program modules and other data for the computer 510. In FIG. 5, for example, hard disk drive 541 is illustrated as storing operating system 544, application programs 545, other program modules 546, and program data 547. Note that these components can either be the same as or different from operating system 534, application programs 535, other program modules 536, and program data 537. Operating system 544, application programs 545, other program modules 546, and program data 547 are given different numbers here to illustrate that, at a minimum, they are different copies. A user may enter commands and information into the computer 510 through input devices such as a keyboard 562 and pointing device 561, commonly referred to as a mouse, trackball or touch pad. Other input devices (not shown) may include a microphone, joystick, game pad, satellite dish, scanner, or the like. These and other input devices are often connected to the processing unit 520 through a user input interface 560 that is coupled to the system bus 521, but may be connected by other interface and bus structures, such as a parallel port, game port or a universal serial bus (USB). A monitor 591 or other type of display device is also connected to the system bus 521 via an interface, such as a video interface 590. In addition to the monitor 591, computers may also include other peripheral output devices such as speakers and printer, which may be connected through a output peripheral interface 595.

The computer 510 may operate in a networked environment using logical connections to one or more remote computers, such as a remote computer 580. The remote computer 580 may be a personal computer, a server, a router, a network PC, a peer device or other common network node, and typically includes many or all of the features described above relative to the computer 510. The logical connections depicted in FIG. 5 include a local area network (LAN) 571 and a wide area network (WAN) 573, but may also include other networks. Such networking environments are commonplace in offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other means for establishing communications over the WAN 573, such as the Internet. The modem 572, which may be internal or external, may be connected to the system bus 521 via the user input interface 560, or other appropriate mechanism. In a networked environment, program modules depicted relative to the computer 510, or portions thereof, may be stored in a remote memory storage device. By way of example, and not limitation, FIG. 5 illustrates remote application programs 585 as residing on the remote computer 580 (e.g., in memory of the remote computer 580). It will be appreciated that the network connections shown are exemplary and other means of establishing a communications link between the computers may be used.

Although various exemplary methods, devices, systems, etc., have been described in language specific to structural features and/or methodological acts, it is to be understood that the subject matter defined in the appended claims is not necessarily limited to the specific features or acts described. Rather, the specific features and acts are disclosed as exemplary forms of implementing the claimed subject matter.

1. A computer-implemented method comprising:
declaring a template for a user interface component in a markup language where the template specifies one or more parameters for the user interface component; and
declaring a parent template for a user interface assembly of components in the markup language where the parent template calls for consumption of the template for the user interface component and provides at least one value for the one or more parameters or relies exclusively on a default value or default values for the one or more parameters.

2. The computer-implemented method of claim 1 further comprising displaying the user interface assembly.

3. The computer-implemented method of claim 1 wherein the markup language comprises XML.

4. The computer-implemented method of claim 1 wherein at least one of the one or more parameters comprises a required parameter.

5. The computer-implemented method of claim 1 wherein at least one of the one or more parameters comprises an optional parameter.

6. The computer-implemented method of claim 1 wherein the template for the user interface component includes a default values for at least one of the one or more parameters.

7. The computer-implemented method of claim 1 wherein the user interface component serves as a component for selection using one or more commands issued from a remote control.

8. The computer-implemented method of claim 1 wherein the user interface component serves as a component for selecting or consuming media.

9. A computer-readable medium having computer-executable instructions for performing the method recited in claim 1.

10. A computer-implemented method comprising:
declaring a template for a user interface component in a markup language where the template specifies one or more parameters for the user interface component; and
declaring a parent template for a user interface assembly of components in the markup language where the parent template calls for a first consumption of the user interface component and where the parent template calls for a second consumption of the user interface component.

11. The computer-implemented method of claim 10 where in the called for first consumption, the parent template provides at least one value for the one or more parameters.

12. The computer-implemented method of claim 10 where in the called for second consumption, the parent template provides at least one value for the one or more parameters.

13. The computer-implemented method of claim 10 wherein at least one parameter value differs between the called for first consumption and the called for second consumption of the template for the user interface component.

14. The computer-implemented method of claim 10 wherein at least one of the one or more of the parameters uses a default value.

15. The computer-implemented method of claim 10 wherein the markup language comprises XML.

16. The computer-implemented method of claim 10 wherein the user interface component serves as a component for selection using one or more commands issued from a remote control.

17. The computer-implemented method of claim 10 wherein the user interface component serves as a component for selecting or consuming media.

18. A computer-readable medium having computer-executable instructions for performing the method recited in claim 10.

19. A computer-implemented method comprising:
positioning an icon for a user interface component on a form; and
creating an instance of a template in a markup language for the user interface component where the template specifies one or more parameters for the user interface component.

20. The computer-implemented method of claim 19 wherein the instance of the template comprises a child of a parent template.
